(19) United States
(12) Patent Application Publication
(10) Pub. No.: US 2009/0142157 A1
(43) Pub. Date: Jun. 4, 2009

(54) FASTENING STRUCTURE AND ASSEMBLING METHOD THEREOF

(75) Inventors: He-Li Wang, Shenzhen City (CN); Hong Li, Shenzhen City (CN); Ting Zhang, Shenzhen City (CN); Ting-Ting Zhao, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/164,130

(22) Filed: Jun. 30, 2008

(30) Foreign Application Priority Data
Nov. 30, 2007 (CN) 200710202806.9

(51) Int. Cl. F16B 17/00

(52) U.S. Cl. 411/337; 29/525.11

(57) ABSTRACT

A fastening structure for fastening a hardware component is disclosed. The fastening structure includes a supporting portion defining a through stepped hole including a small-diameter hole and a large-diameter hole. Furthermore, the fastening structure includes a nut wedged into the large-diameter hole. A screw may successively passing through the hardware component and the small-diameter hole to screwably engage with the nut.

### BACKGROUND

1. Field of the Invention

Embodiments of the present disclosure generally relate to a fastening structure, and more particularly to a system and method for fastening a screw to a hardware component.

2. Description of Related Art

Fastening structures are extensively used in mechanical assemblies. In a typical mechanical assembly, a fastening structure is used to fasten a hardware component, such as a board, or a frame, for example. The fastening structure includes a supporting portion defining a first through hole therein, a screw, and a nut. The hardware component to be fastened by the fastening structure defines a second through hole. It may be understood that an outer diameter of the nut is typically slightly larger than a diameter of the first through hole in order for proper fastening between the hardware component and the fastening structure.

In assembly, the nut is forced to wedge into the first through hole to establish a first mechanical joint between the nut and the supporting portion. Subsequently, the screw passes through the second through hole to engage with the nut to establish a second mechanical joint between the screw and the nut. As a result, the hardware component is fixed onto the supporting portion of the fastening structure based on the first mechanical joint and the second mechanical joint.

In the above mentioned mechanism assembly, a wedging action of the nut into the supporting portion and a passing action of the screw through the second through hole are always made along the same direction. Therefore, when a drawing force is applied on the screw, the fastening structure may be separated and fails to keep fastening the hardware component.

### SUMMARY

A fastening structure for fastening a hardware component, the fastening structure includes a supporting portion defining a through stepped hole including a small-diameter hole and a large-diameter hole, a nut inserted and frictionally coupled into the large-diameter hole, and a screw for successively passing through the hardware component and the small-diameter hole to screwably engage with the nut.

A fastening structure includes a supporting portion defining a through hole, a nut wedged into the through hole along a wedging direction, and a screw for engaging with the nut along a direction opposite to the wedging direction.

An assembling method for fastening a hardware component onto a supporting portion, the assembling method includes inserting and coupling a nut into a large-diameter hole of a through stepped hole defined in the supporting portion along a first direction, and screwing the screw through the hardware component and through a small-diameter hole of the through stepped hole in order to screwably engage with the nut along a second direction opposite to the first direction.

Other systems, methods, features, and advantages of the present fastening structure and assembling method thereof will be or become apparent to one with ordinary skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present fastening structure and assembling method thereof can be better understood with reference to the following drawings. The components in the drawings are not necessarily to scale, emphasis instead being placed upon clearly illustrating the principles of the present device. Moreover, in the drawings, like reference numerals designate corresponding components throughout the several views.

FIG. 1 is a cross-sectional view of one embodiment of a fastening structure of the present disclosure;

FIG. 2 is a cross-sectional view of one embodiment of a supporting portion of the fastening structure molded by two dies;

FIG. 3 is a cross-sectional view of one embodiment of the fastening structure for fastening a hardware component; and

FIG. 4 is a cross-sectional view of one embodiment of the hardware component fastened onto the supporting portion by the fastening structure.

### DETAILED DESCRIPTION OF CERTAIN INVENTIVE EMBODIMENTS

Reference will now be made to the drawings to describe certain inventive embodiments of the present fastening structure and assembling method thereof, in detail.

As used herein, the term, “hardware component” is defined to include any object that needs to be fastened or attached to another object. The term may be used to define various computer components that need to be fastened together, or the term may be used to define various non-computer components that need to be fastened together. As non-limiting examples, the term may include fastening together one or more metal cases, wood blocks, plastic pieces, and metal sheets, for example.

As used herein, the term, “wedge” is defined as to insert and forcibly couple and object with another object. In one embodiment, the coupling may be via friction and/or by a larger object being inserted into a slightly smaller object.

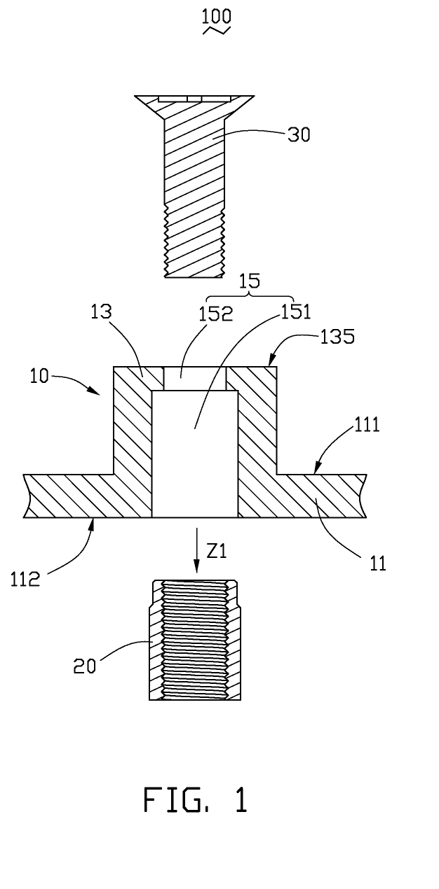

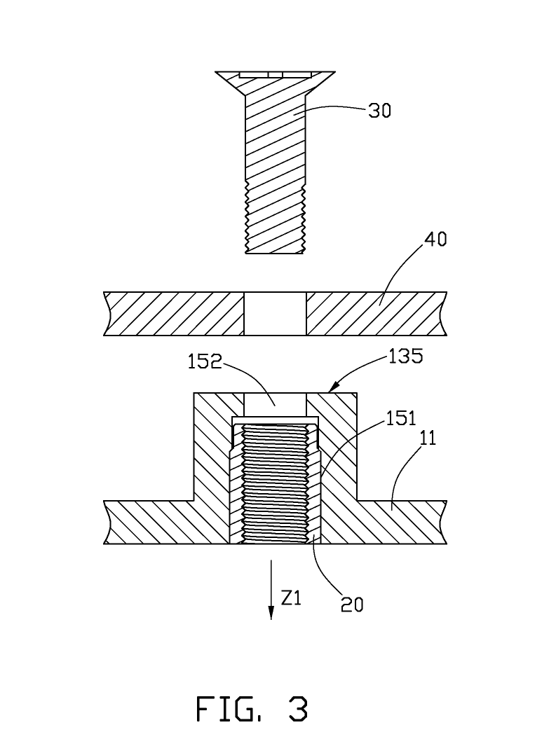

Referring to FIGS. 1-3, a fastening structure 100 in accordance with one embodiment of the present disclosure is used to fasten a hardware component 40. The fastening structure 100 includes a supporting portion 10, a nut 20, and a screw 30. The nut 20 and the hardware component 40 are disposed on opposite sides of the supporting portion 10 correspondingly. The screw 30 passes through the hardware component 40 and the supporting portion 10 to screwably engage with the nut 20, so as to cooperatively fasten the hardware component 40 onto the supporting portion 10. A detailed structure of the fastening structure 100 will be described as follows.

The supporting portion 10 includes a base 11 and a protrusion 13. The base 11 has a first surface 111 and a second surface 112 on an opposite side of the first surface 111. The protrusion 13 protrudes from the base 11 and extends from the first surface 112 of the supporting portion 10.

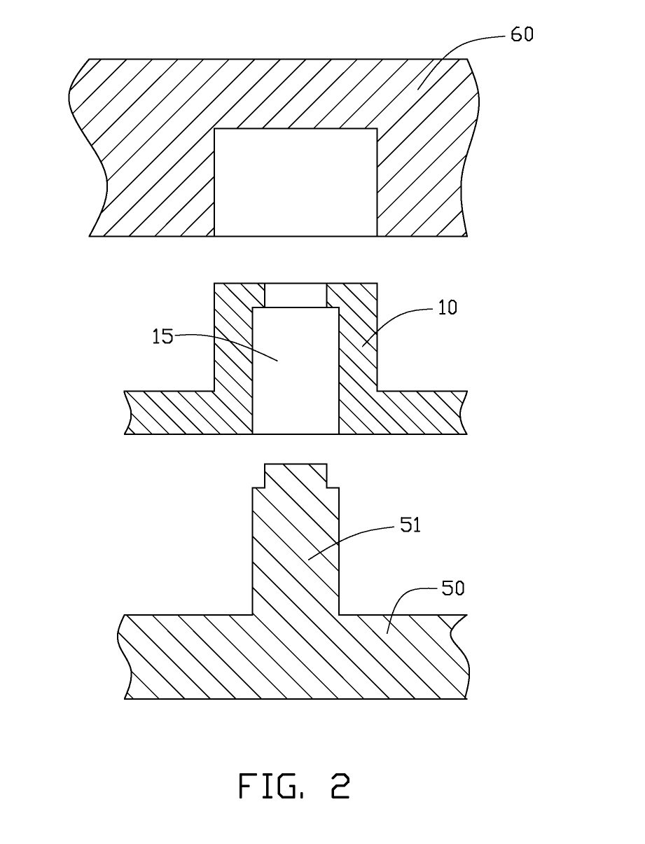

A through stepped hole 15 is defined in the supporting portion 10. The through stepped hole 15 is composed of a large-diameter hole 151 and a small-diameter hole 152, where the large-diameter hole 151 has a larger diameter than the small-diameter hole 152. The small-diameter hole 152 is defined in a free end of the protrusion 13 for allowing the screw 30 to pass through. The large-diameter hole 151 is defined in the base 11 and is defined in the protrusion 13 for receiving the nut 20. In one embodiment, a diameter of the nut 20 may be substantially larger than that of the small-diameter hole 152, and slightly larger than that of the large-diameter hole 151. Also referring to FIG. 2, the supporting portion 10 is molded by a male die 50 and a female die 60, and the through stepped hole 15 is molded by a stepped projection 51 of the male die 50. In one embodiment, the nut 20 comprises grooves positioned on an inside surface of the nut 20 to screwably engage with the screw 30.

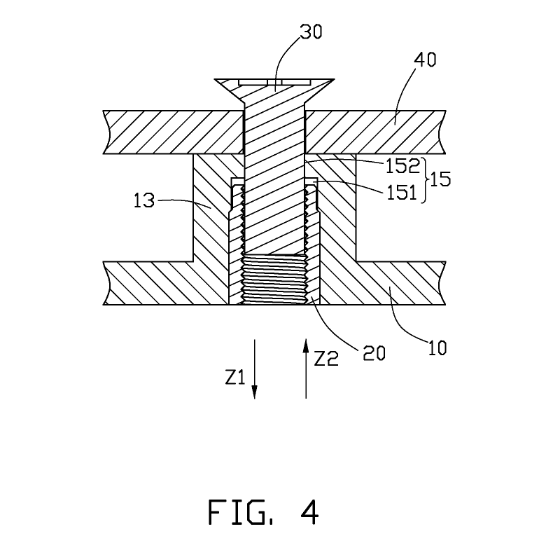

Further referring to FIG. 4, in assembly, the nut 20 is wedged into the large-diameter hole 152 from the second surface 112 of the supporting portion 10 along a wedging direction Z2 opposite to a draft direction Z1 of the through stepped hole 15. The hardware component 40 is located on an end surface 135 of the protrusion 13. The screw 30 successively passes through the hardware component 40 and in the small-diameter hole 152 along the draft direction Z1 to screwably engage with the nut 20. As a result, the hardware component 40 is fastened onto the supporting portion 10 by the fastening structure 100.

In the above mentioned fastening structure 100, the wedging direction Z2 of the nut 20 into the supporting portion 10 is opposite to the draft direction Z1. Therefore, the nut 20 is prevented from falling out of the supporting portion 10, when a drawing force (not labeled) is applied on the screw 30 that has been engaged with the nut 20.

The foregoing description of certain inventive embodiments of the present disclosure has been presented only for the purposes of illustration and description and is not intended to be exhaustive or to limit the present disclosure to the precise forms disclosed. Many modifications and variations are possible in light of the above teaching. The embodiments were chosen and described in order to explain the principles of the present disclosure and their practical application so as to enable others skilled in the art to utilize the invention and various embodiments and with various modifications as are suited to the componenticular use contemplated. Alternative embodiments will become apparent to those skilled in the art to which the present disclosure pertains without decomponenting from its spirit and scope. Accordingly, the scope of the present disclosure is defined by the appended claims rather than the foregoing description and the exemplary embodiments described therein.

What is claimed is:

1. A fastening structure for fastening a hardware component, the fastening structure comprising:
a supporting portion defining a through stepped hole comprising a small-diameter hole and a large-diameter hole;
a nut wedged into the large-diameter hole; and
a screw for successively passing through the hardware component and the small-diameter hole to screwably engage with the nut.

2. The fastening structure as claimed in claim 1, wherein the supporting portion comprises a base and a protrusion, wherein the small-diameter hole is defined in a free end of the protrusion, and wherein the large-diameter hole is defined in the base and the protrusion of the fastening structure.

3. The fastening structure as claimed in claim 1, wherein a diameter of the nut is slightly larger than a diameter of the large-diameter hole.

4. A fastening structure comprising:
a supporting portion defining a through hole;
a nut wedged into the through hole along a wedging direction; and
a screw for engaging with the nut along a direction opposite to the wedging direction.

5. The fastening structure as claimed in claim 4, wherein the through hole is a stepped hole.

6. The fastening structure as claimed in claim 5, wherein the through hole is molded by a stepped projection of a male die.

7. The fastening structure as claimed in claim 6, wherein the wedging direction is opposite to a draft direction of the through hole.

8. The fastening structure as claimed in claim 5, wherein the supporting portion comprises a base and a protrusion, wherein the through hole has a small-diameter hole and a large-diameter hole, and wherein the small-diameter hole defined in a free end of the protrusion, and the large-diameter hole defined both in the base and the protrusion.

9. The fastening structure as claimed in claim 8, wherein the diameter of the nut is slightly larger than that of the large-diameter hole.

10. An assembling method for fastening a hardware component onto a supporting portion, the assembling method comprising:
inserting and wedging a nut into a large-diameter hole of a through stepped hole defined in the supporting portion along a first direction; and
screwing the screw through the hardware component and through a small-diameter hole of the through stepped hole in order to screwably engage with the nut along a second direction opposite to the first direction.

11. The assembling method as claimed in claim 10, wherein the through stepped hole is molded by a stepped projection of a male die.
